(19) United States
(12) Patent Application Publication
(10) Pub. No.: US 2017/0003924 A1
(43) Pub. Date: Jan. 5, 2017

(54) REPLAY OF RESPONSIVE WEB DESIGN (RWD) DESIGNED WEB SITES

(71) Applicant: International Business Machines Corporation, Armonk, NY (US)

(72) Inventors: Damie L. Brooks, Albuquerque, NM (US); Jiantao Huang, San Francisco, CA (US); Lalith Kumar Maddali, Fremont, CA (US); Sukhbir Singh, Hayward, CA (US)

(21) Appl. No.: 14/754,845

(22) Filed: Jun. 30, 2015

(51) Int. Cl. G06F 3/14; G06F 3/0481; G09G 5/00; H04L 29/08

(52) U.S. Cl. CPC G06F 3/1415; H04L 67/02; G06F 3/0481; G09G 5/005; G09G 2354/00; G09G 2370/027

(57) ABSTRACT

Embodiments of the present invention provide a method, system and computer program product for the replay of RWD designed Web sites. In an embodiment of the invention, a method for replaying RWD designed Web sites is provided. The method includes recording in a replay server different events received from end user interactions with different RWD Web pages of a Web site rendered in a display of the end user from over a computer communications network. The method also includes identifying display dimensions of the display and storing the display dimensions in connection with the recorded different events. The method yet further includes rendering one or more of the RWD Web pages of the Web site in a renderer coupled to the replay server using the stored display dimensions. Finally, the method includes replaying the stream of events by the replay server in the renderer.

### BACKGROUND OF THE INVENTION

Field of the Invention

The present invention relates to Web page rendering and more particularly to resizing a display of a Web page.

Description of the Related Art

The advent of the World Wide Web (the “Web”) created a remarkable new medium in which different ideas could be exchanged in different forms to appeal to a massive range of individuals worldwide. The medium of the Web essentially is a document exchange medium through which Web page authors create Web pages of text, graphics, audio and video material and end users consume the authored pages. Depending upon the sophistication of the author of a Web page and the intended audience viewing the Web page, the Web page can vary from static content, defined by the author in terms of look and feel, to dynamically generated and placed content determined at run-time depending upon the context of a request for the Web page and the display capabilities of the requesting end user. In this regard, advanced forms of Web page authoring and distribution rely upon the style sheet concept so as to separate the definition of the underlying content of a Web page from the way in which the content is present.

Notably, Web page design in the twenty-first century cannot assume a uniform display device in which a Web page is to be displayed. At the minimum, mobile computing in the form of tablets and smartphones has shattered the notion that the most common computer used by the end user to view Web pages is the desktop computer. Rather, is it is now apparent, displaying a Web page on a mobile device is as likely as any other manner of displaying a Web page. To account for this possibility, oftentimes a Web server responding to a request for a Web page will a priori determine the nature of the device from which the request is received so as to selectively serve one or more pages of a version of the requested Web site consistent with the determined nature of the device.

Responsive web design (RWD) is an approach to Web page design intended to provide an optimal viewing experience for the end user. That is, RWD intends upon producing a Web site that is easy to ready by the end user and easy to navigate, requiring a minimum amount of resizing, panning, and scrolling across a wide range of devices ranging from a desktop computer to a mobile phone. A site designed in accordance with RWD generally adapts the layout of the Web site to the viewing environment by using fluid, proportion-based grids, flexible images and cascading style sheet media queries. More particularly, page elements are sized to be in relative units such as percentages, rather than absolute units such as pixels or points. Flexible images also are sized in relative units so as to prevent the images from displaying outside a corresponding containing element. Finally, media queries allow the Web page to use different cacscading style sheet style rules based upon the characteristics of the display of the device—most commonly the width of the browser displaying the Web page in the device.

RWD designed Web sites are not without complication. In this regard, an RWD designed Web site can prove problematic during replay of the RWD designed Web site. Replay refers to the recording of a Web site and the localized accessing of the recorded Web site for the purpose of usability testing. Localized access to a recorded Web site specifically avoids abnormal operating conditions associated with a live presentation of the Web site so as to facilitate normalized testing of the recorded Web site. Yet, a localized form of a Web site does not account for the screen sensitive nature of an RSW designed Web site.

### BRIEF SUMMARY OF THE INVENTION

Embodiments of the present invention address deficiencies of the art in respect to RWD and provide a novel and non-obvious method, system and computer program product for the replay of RWD designed Web sites. In an embodiment of the invention, a method for replaying RWD designed Web sites is provided. The method includes recording in a replay server different events received from end user interactions with different RWD Web pages of a Web site rendered in a display of the end user from over a computer communications network. The method also includes identifying display dimensions of the display and storing the display dimensions in connection with the recorded different events. The method yet further includes rendering one or more of the RWD Web pages of the Web site in a renderer coupled to the replay server using the stored display dimensions. Finally, the method includes replaying the stream of events by the replay server in the renderer.

In one aspect of the embodiment, the display of the end user is disposed in a mobile device and the renderer is disposed in a server also hosting execution of the replay server. In another aspect of the embodiment the display of the end user is disposed in a mobile device and the renderer is disposed in a desktop computer communicatively coupled to a server hosting execution of the replay server. In yet another aspect of the embodiment, the renderer is browser based. Finally, in even yet another aspect of the embodiment, the RWD Web pages are configured to change in visual presentation responsive to detected dimensions of a display in which the RWD Web pages are rendered.

In another embodiment of the invention, a Web site replay data processing system is configured for replaying RWD designed Web sites. The system includes a server with memory and at least one processor and a replay server executing in the memory of the server. The replay server records different events received from end user interactions with different RWD Web pages of a Web site rendered in a display of the end user from over a computer communications network, identifies display dimensions of the display and stores the display dimensions in connection with the recorded different events. Finally, the system includes a renderer coupled to the replay server The replay server additionally directs the renderer to render one or more of the RWD Web pages of the Web site using the stored display dimensions, and the replay server replays the stream of events in the renderer.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for the replay of RWD designed Web sites;

FIG. 2 is a schematic illustration of a Web site replay data processing system configured for replay of RWD designed Web sites; and,

FIG. 3 is a flow chart illustrating a process for replay of RWD designed Web sites.

### DETAILED DESCRIPTION OF THE INVENTION

Embodiments of the invention provide for replay of RWD designed Web sites. In accordance with an embodiment of the invention, a stream of events are collected by a replay server from detected end user interactions with a Web site defined by a collection of RWD Web pages. The dimensional characteristics of a display in which the Web site is rendered is recorded in the replay server. Thereafter, the stream of events are replayed by the replay server and the RWD Web pages of the Web site are displayed utilizing a Web site renderer employing the dimensional characteristics recorded in the replay server. In this way, the Web site is replayed utilizing display dimensions consistent with the intended RWD of the Web pages of the Web site.

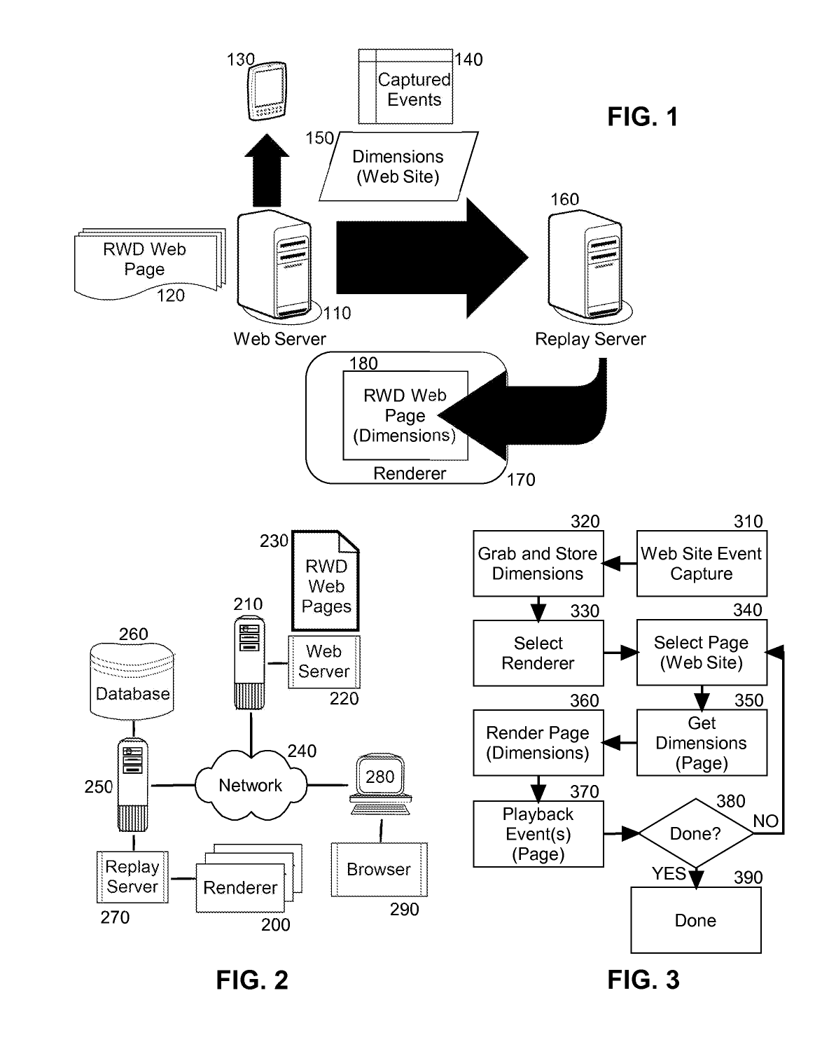

In further illustration, FIG. 1 is a pictorial illustration of a process for the replay of RWD designed Web sites. As shown in FIG. 1, a Web server 110 serves one or more RWD designed Web pages 120 of a Web site to a display device 130 such as a personal computer or mobile computing device. Replay server 160 monitors the service of the RWD designed Web pages 120 and acquires events 140 occurring in the RWD designed Web pages 120 and the dimensional characteristics 150 of the display of the RWD designed Web pages 120 in the display device 130. Thereafter, on playback of the RWD designed Web pages 120 in a renderer 170 selected by the replay server 160, such as a particular type of Web browser, played back ones the RWD designed Web pages 180 are presented in the renderer 170 in accordance with the dimensional characteristics 150.

The process described in connection with FIG. 1 can be implemented in a Web site replay data processing system. In yet further illustration, FIG. 2 schematically shows a Web site replay data processing system configured for replay of RWD designed Web sites. The system includes a first host computing system 210 with memory and at least one processor supporting the execution of a Web server 220 serving one or more RWD designed Web pages 230 to different requesting end users over computer communications network 240. A capture server (not shown) further can be integrated into the Web server 220 through a library of a software development kit and can be enabled to execute in each display device of an end user in order capture end user interactions by each end user with the RWD designed Web pages 230 and to store those interactions in database 260. The system also includes a second host computing system 250 with memory and at least one processor supporting the execution of a replay server 270 playing back the captured end user interactions with the RWD designed Web pages 230 according to pre-recorded events in database 260 captured during monitored access to the RWC designed Web pages 230 by one or more end users.

The replay server 270 includes program code enabled upon execution in the second host computing system 250 to identify the dimensions of a display device displaying the RWD designed Web pages 230 during capturing of the end user interactions into the database 260. The program code initially is enabled upon execution in the second host computing system 250 to select a renderer 200 either resident in the second host computing system 250, or in remotely coupled computer 280, and to display the RWD Web pages 230 in the selected renderer 200 utilizing the identified dimensions. To the extent the selected renderer 200 is resident in the content browser 290 of the remotely coupled computer 280, the program code is enabled to provide the dimensions to the selected renderer 200 for use in sizing an Iframe of the content browser 290 for the selected renderer 200 in which the RWD Web pages 230 are rendered. Alternatively, in the former instance, to the extent the selected renderer 200 executes in the second host computing platform 250 and is not disposed in the browser 290 of the remotely coupled computer 280, the dimensions are provided to the selected renderer 200 by way of shared memory in the second host computing platform 250 between the replay server 270 and the selected renderer 290.

In even yet further illustration, FIG. 3 is a flow chart illustrating a process for replay of RWD designed Web sites. The process begins in block 320 with the capturing of events during live interactions as between an end user and a Web site of one or more RWD designed Web pages. In block 320, the display dimensions of the display of the RWD designed Web pages are determined and stored in connection with the captured events. In block 330, during replay, a renderer amongst a set of renderers is selected to receive the RWD designed Web pages and a first one of the RWD designed Web pages is selected for replay in block 340.

In block 350, the dimensions for the first one of the RWD designed Web pages stored in connection with the captured events are retrieved and in block 360, the first one of the RWD designed Web pages is rendered in the selected renderer utilizing the retrieved dimensions. Finally, in block 370, the captured events for the first one of the RWD designed Web pages are played back in the renderer. Thereafter, in decision block 380 if additional RWD designed Web pages are to be processed, in block 340 a next one of the RWD designed Web pages is selected for replay and the process repeats through block 350. When no further RWD designed Web pages are to be processed, in block 390 the process ends.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for replaying responsive Web design (RWD) designed Web sites, the method comprising:
recording in a replay server different events received from end user interactions with different RWD Web pages of a Web site rendered in a display of the end user from over a computer communications network;
identifying display dimensions of the display and storing the display dimensions in connection with the recorded different events;
rendering one or more of the RWD Web pages of the Web site in a renderer coupled to the replay server using the stored display dimensions; and,
replaying the stream of events by the replay server in the renderer.

2. The method of claim 1, wherein the display of the end user is disposed in a mobile device and the renderer is disposed in a server also hosting execution of the replay server.

3. The method of claim 1, wherein the display of the end user is disposed in a mobile device and the renderer is disposed in a desktop computer communicatively coupled to a server hosting execution of the replay server.

4. The method of claim 1, wherein the renderer is browser based.

5. The method of claim 1, wherein the RWD Web pages are configured to change in visual presentation responsive to detected dimensions of a display in which the RWD Web pages are rendered.

6. A Web site replay data processing system configured for replaying responsive Web design (RWD) designed Web sites, the system comprising:
a server comprising memory and at least one processor;
a replay server executing in the memory of the server, the replay server recording different events received from end user interactions with different RWD Web pages of a Web site rendered in a display of the end user from over a computer communications network, identifying display dimensions of the display and storing the display dimensions in connection with the recorded different events; and,
a renderer coupled to the replay server, the replay server additionally directing the renderer to render one or more of the RWD Web pages of the Web site using the stored display dimensions, the replay server replaying the stream of events in the renderer.

7. The system of claim 6, wherein the display of the end user is disposed in a mobile device and the renderer is disposed in a server also hosting execution of the replay server.

8. The system of claim 6, wherein the display of the end user is disposed in a mobile device and the renderer is disposed in a desktop computer communicatively coupled to a server hosting execution of the replay server.

9. The system of claim 6, wherein the renderer is browser based.

10. The system of claim 6, wherein the RWD Web pages are configured to change in visual presentation responsive to detected dimensions of a display in which the RWD Web pages are rendered.

11. A computer program product for replaying responsive Web design (RWD) designed Web sites, the computer program product comprising a computer readable storage medium having program instructions embodied therewith, the program instructions executable by a device to cause the device to perform a method comprising:
recording in a replay server different events received from end user interactions with different RWD Web pages of a Web site rendered in a display of the end user from over a computer communications network;
identifying display dimensions of the display and storing the display dimensions in connection with the recorded different events;
rendering one or more of the RWD Web pages of the Web site in a renderer coupled to the replay server using the stored display dimensions; and,
replaying the stream of events by the replay server in the renderer.

12. The computer program product of claim 11, wherein the display of the end user is disposed in a mobile device and the renderer is disposed in a server also hosting execution of the replay server.

13. The computer program product of claim 11, wherein the display of the end user is disposed in a mobile device and the renderer is disposed in a desktop computer communicatively coupled to a server hosting execution of the replay server.

14. The computer program product of claim 11, wherein the renderer is browser based.

15. The computer program product of claim 11, wherein the RWD Web pages are configured to change in visual presentation responsive to detected dimensions of a display in which the RWD Web pages are rendered.
